(19) United States
(12) Patent Application Publication
(10) Pub. No.: US 2010/0241996 A1
(43) Pub. Date: Sep. 23, 2010

(54) XMB submenu preview

(76) Inventors: Tracy Wai Ho, San Diego, CA (US); Yuko Nishikawa, La Jolla, CA (US); Yuko Suzuki, Tokyo (JP); Hyehoon Yi, Escondido, CA (US)

Correspondence Address: MILLER PATENT SERVICES, 2500 DOCKERY LANE, RALEIGH, NC, 27606, US

(21) Appl. No.: 12/383,034

(22) Filed: Mar. 19, 2009

(51) Int. Cl. G06F 3/048

(52) U.S. Cl. 715/841

(57) ABSTRACT

A television menu system. A cross-media bar menu displays on a display upon actuation of a menu command. The cross-media bar menu displays a plurality of menu selections arranged in a crossing pattern. One of the menu selections serves as a focused menu selection either by default when the menu command is actuated or when focused upon by virtue of navigation to an icon by the user via the television interface device. A display window situated outside the cross-media bar display, displays a preview list of menu actions that can be taken by the user if the currently focused menu selection is selected by the user. The preview list is not a functional menu and does not form a part of the menu system. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

The UI structure of Sony's cross media bar (XMB) user interface has won many accolades and awards. But, due to the UI structure, there is an inability to preview contents for the focused item. Extra steps have to be taken in order to view sub-menu items (e.g. user must select the focused item to see sub-items) with the possibility that the user still does not find what s/he is looking for. This causes a less than optimal user experience. Other UI structures allow for a “cascading” menu effect which automatically displays sub-items as they exist in the menu structure. The focused item always results in automatic display of the sub-items.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example depiction of a cross media bar (XMB) user interface as used in a television, video player device or game station.

FIG. 2 is an example depiction of a cross media bar user interface (UI) utilizing a submenu preview window in a manner consistent with certain embodiments of the present invention.

FIG. 3 is a flow chart of operation of a cross media bar preview windo system consistent with certain embodiments of the present invention.

FIG. 4 is a television (TV) device consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “processor”, “controller”, “CPU”, “Computer” and the like as used herein encompasses both hard programmed, special purpose, general purpose and programmable devices and may encompass a plurality of such devices or a single device in either a distributed or centralized configuration without limitation.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

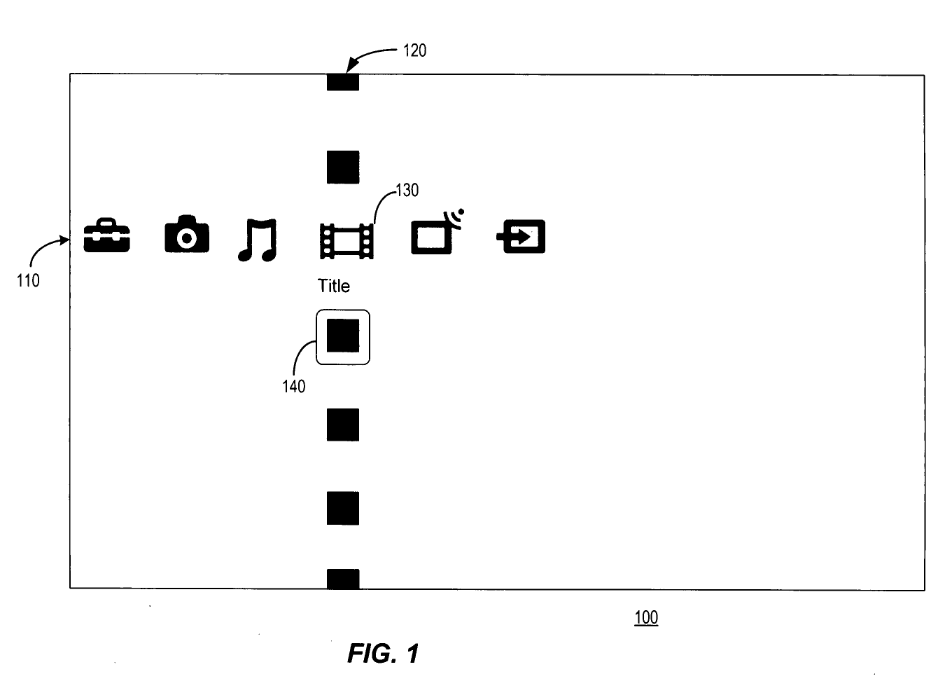

Turning now to FIG. 1, an example cross media bar (XMB) menu system is depicted as 100. Menu selections are arranged in a cross patterns with main functional groups arranged horizontally as shown as 110 and related functions arranged vertically as 120. In this example, for instance, icon 130 depicts movie selections that are available. The movie that is currently at the focus is shown as 140 as depicted by the box surrounding the icon (shown only as a black square here for ease of illustration. The user navigates using conventional navigation techniques, that is, using left, right, up and down, and select keys of a remote controller device. When a menu selection is in focus, it is selected using the select or enter key of the remote controller device.

As previously noted, due to the existing UI structure, the user is unable to see what sub-menu items are available in a particular focused menu selection without actually making the selection. This, unfortunately renders the user interface more cumbersome to use in some instances. In accord with certain example embodiments consistent herewith, a preview display is provided in a separate view still window to give the user the ability to preview a menu selection's submenu items. This saves the user from the extra steps of having to enter and exit a focused item of the XMB if the user does not find what s/he is looking for.

Hence, in certain implementations, an XMB user interface is provided for navigating through a plurality of menus. The user interface provides automatic preview display of sub-item menu for a parent menu item. The preview display is in a separate window which is not immediately attached to the parent menu item, and is not a menu, per se, but an indication of what is in the menu. This provides the user, the convenience of previewing any sub-item menu without the need of entry/exit from the parent menu item. Furthermore, if the user cannot find a required item in this sub-item menu the user can switch to another item to display its sub-item menu.

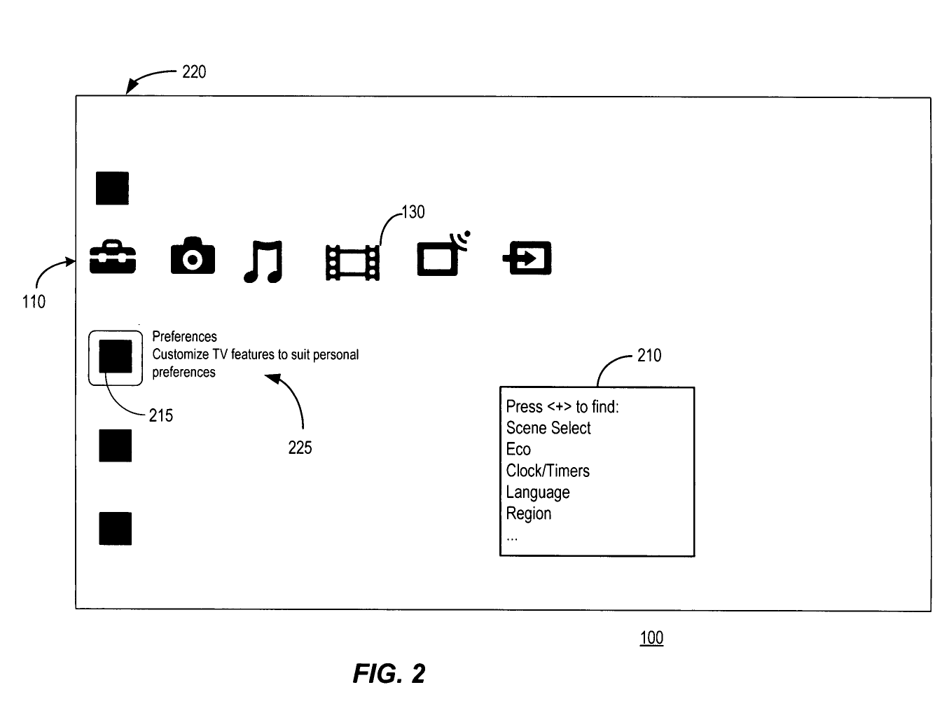

Now consider FIG. 2, which shows another example of the XMB interface incorporating a sub-menu preview window 210. When icon 215 is the focus as shown, the conventional XMB provides both an informative icon and in some instances a text explanation of the category. Preview window 210 takes the information a step further by providing a preview window 210 that give a user a list of items that can be selected from a submenu if the focused icon is selected by the select button of the remote controller. Upon selecting this icon, another bar of selections appears from which the user can select items from the.XMB menu, with the user now armed with the exact menu selections that will be revealed in this category. Note that the preview display window 210 is in a separate window which is not immediately attached to the parent menu item 215, and is not a menu, per se, but an indication of what is in the sub-menu associated with icon 215. A preview window such as window 210 can be provided for any or all of the icons in either the horizontal or vertical Icons of the XMB menu.

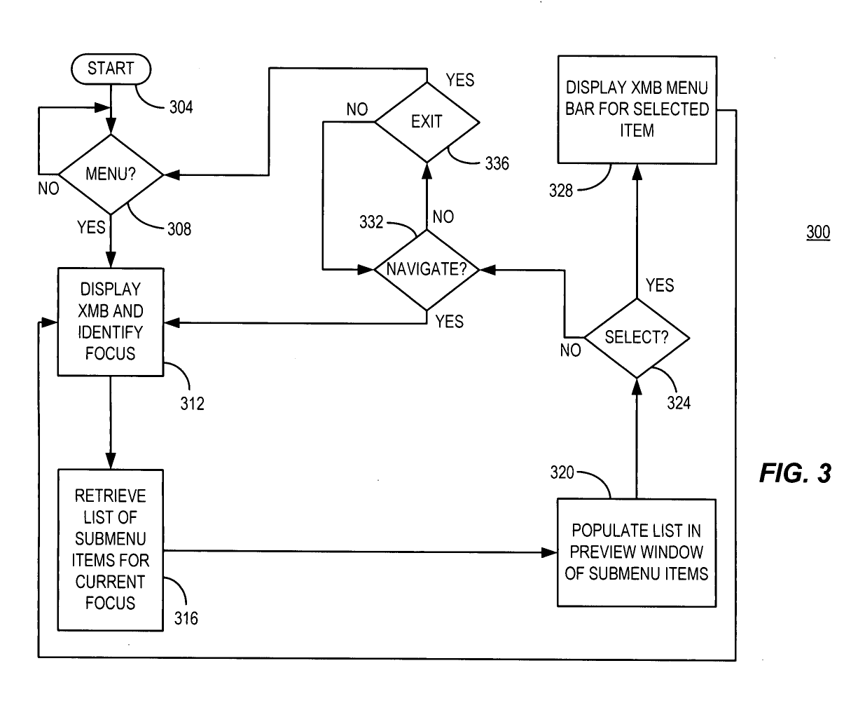

FIG. 3 depicts a flow chart 300 of an example process for implementation of a XMB menu system with sub-menu preview windows consistent with certain embodiments starting at 304. For purposes of this flow chart, the actions associated with menu selections are ignored for clarity. If, at 308, the user invokes the XMB menu by use of a menu key on a remote controller (for example), the XMB menu structure appears on the display at 312 and the icon of focus is identified. At 316, a list of submenu items for the icon currently in focus is retrieved from a database and used to populate a list in a preview window of submenu items displayed on the display at 320.

If a menu or submenu item is selected at 324, an XMB menu bar or other menu is retrieved and displayed at 328. Control can then return to 312 so that the XMB focus can be identified if further submenus can be previewed. If a menu item is not selected at 324, but the user navigates to a new menu item at 332, control again returns to 312 for identification of the focus and display of a further or menu or submenu preview window. If the user does not navigate at 332, but chooses to exit at 336, control returns to 308 to await the next invocation of the menu system.

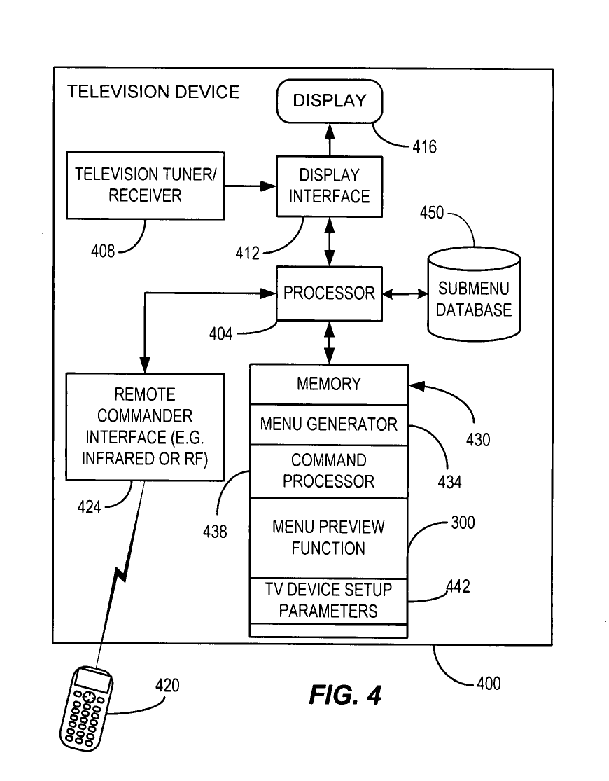

Referring now to FIG. 4, an example television device 400 is depicted. In accordance with implementations consistent with the present invention, the television device 400 operates utilizing its own processor or processors 404 or state machine that controls operation of the television device. The processor 404 controls operation of a television receiver/tuner 408 and display interface 412 to facilitate display on the display panel 416 in a more or less conventional manner.

Video signals can be provided to the television tuner/receiver 400 via a cable television system or any other suitable source of video (e.g., recorded media, satellite, Internet, etc.). Such video is passed through the display interface 412 (possibly after being converted to a specified format) to display 416 in a conventional manner.

In the embodiment depicted, the various functions of the television device are controlled via a remote commander 420, such as an infrared remote commander or a radiofrequency remote commander. In other embodiments, other user interface mechanisms including front panel controls and the like may be used. Commands from remote commander 420 are passed to the remote commander interface 424, which interprets the commands and passes information regarding such commands to processor 404, which may incorporate a hardware based processing system or a software based microcomputer system or the like. In the embodiment depicted, the processor has an associated memory 430 that stores various processes, such as menu generation at 434, command processing at 438 and menu preview function as depicted in process 300. The memory 430 may also store TV setup parameters 442 and other functions as will be appreciated by those skilled in the art.

In operation, the television device 400 generates an XMB menu that is displayed via the display interface on display 416. This menu incorporates various functions and sub-functions built into the television device. When the menu is invoked, the menu preview function is also invoked so that the processor 404 retrieves submenu functions from the database 450 in order to populate a window as previously described.

Thus, in accord with certain embodiments, a television menu system has a cross-media bar menu that displays on a display upon actuation of a menu command by a user from a television interface device. The cross-media bar menu displays a plurality of menu selections arranged in a crossing pattern, wherein, one of the menu selections of the cross-media bar serves as a focused menu selection either by default when the menu command is actuated or when focused upon by virtue of navigation to an icon by the user via the television interface device. A display window is situated outside the cross-media bar display, wherein the display window displays a preview list of menu actions that can be taken by the user if the currently focused menu selection is selected by the user, and wherein the preview list is not a functional menu and does not form a part of the menu system.

In certain implementations, the television interface device comprises a television remote controller that sends signals to a television remote controller interface. In certain implementations, the menu selections are represented in the cross-media bar menu display as a plurality of icons arranged in a crossing pattern. In certain implementations, the display window is displayed only when the focus appears on certain of the menu selections. In certain implementations, the display window is populated with menu functions that are stored in a database, wherein the stored menu functions are retrieved from the database based upon the currently focused cross-media bar menu selection. In certain implementations, the system repopulates the preview list of menu items upon receipt of user commands to navigate to a different menu selection as the focus.

Another television menu system consistent with certain embodiments has a cross-media bar menu that displays on a display upon actuation of a menu command by a user from a television interface device, wherein the menu selections are represented in the cross-media bar menu display as a plurality of icons arranged in a crossing pattern. The cross-media bar menu displays a plurality of menu selections arranged in a crossing pattern. One of the menu selections of the cross-media bar serves as a focused menu selection either by default when the menu command is actuated or when focused upon by virtue of navigation to an icon by the user via the television interface device. The television interface device receives information from a television remote controller that sends signals to a television remote controller interface. A display window is situated outside the cross-media bar display, wherein the display window displays a preview list of menu actions that can be taken by the user if the currently focused menu selection is one of a subset of menu items, and wherein the preview list is not a functional menu and does not form a part of the menu system. The display window is populated with menu functions that are stored in a database, wherein the stored menu functions are retrieved from the database based upon the currently focused cross-media bar menu selection.

A tangible computer readable electronic storage medium can store instructions which, when executed on one or more programmed processors, carry out any of the methods described herein.

Those skilled in the art will recognize, upon consideration of the above teachings, that certain of the above exemplary embodiments are based upon use of a programmed processor such as 404. However, the invention is not limited to such exemplary embodiments, since other embodiments could be implemented using hardware component equivalents such as special purpose hardware, state machines and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments. Instructions for implementing any of the processes described herein can be carried out on the programmed processor and such instructions stored on an electronic storage medium such as memory device 430, which can be any suitable electronic storage device such as flash memory.

While certain illustrative embodiments have been described, it is evident that many alternatives, modifications, permutations and variations will become apparent to those skilled in the art in light of the foregoing description.

What is claimed is:

1. A television menu system, comprising:
a cross-media bar menu that displays on a display upon actuation of a menu command by a user from a television interface device;
the cross-media bar menu displaying a plurality of menu selections arranged in a crossing pattern;
wherein, one of the menu selections of the cross-media bar serves as a focused menu selection either by default when the menu command is actuated or when focused upon by virtue of navigation to an icon by the user via the television interface device; and
a display window situated outside the cross-media bar display, wherein the display window displays a preview list of menu actions that can be taken by the user if the currently focused menu selection is selected by the user, and wherein the preview list is not a functional menu and does not form a part of the menu system.

2. The television menu system according to claim 1, wherein the television interface device comprises a television remote controller that sends signals to a television remote controller interface.

3. The television menu system according to claim 1, wherein the menu selections are represented in the cross-media bar menu display as a plurality of icons arranged in a crossing pattern.

4. The television menu system according to claim 1, wherein the display window is displayed only when the focus appears on certain of the menu selections.

5. The television menu system according to claim 1, wherein the display window is populated with menu functions that are stored in a database, wherein the stored menu functions are retrieved from the database based upon the currently focused cross-media bar menu selection.

6. The television menu system according to claim 1, further comprising repopulating the preview list of menu items upon receipt of user commands to navigate to a different menu selection as the focus.

7. A tangible computer readable electronic storage medium storing instructions which, when executed on one or more programmed processors, implement a television menu system according to claim 1.

8. A television menu system, comprising:
a cross-media bar menu that displays on a display upon actuation of a menu command by a user from a television interface device, wherein the menu selections are represented in the cross-media bar menu display as a plurality of icons arranged in a crossing pattern;
the cross-media bar menu displaying a plurality of menu selections arranged in a crossing pattern;
wherein, one of the menu selections of the cross-media bar serves as a focused menu selection either by default when the menu command is actuated or when focused upon by virtue of navigation to an icon by the user via the television interface device;
wherein the television interface device comprises a television remote controller that sends signals to a television remote controller interface;
a display window situated outside the cross-media bar display, wherein the display window displays a preview list of menu actions that can be taken by the user if the currently focused menu selection is one of a subset of menu items, and wherein the preview list is not a functional menu and does not form a part of the menu system; and
wherein the display window is populated with menu functions that are stored in a database, wherein the stored menu functions are retrieved from the database based upon the currently focused cross-media bar menu selection.

9. A tangible computer readable electronic storage medium storing instructions which, when executed on one or more programmed processors, implement a television menu system according to claim 8.
